(19) United States
(12) Patent Application Publication
(10) Pub. No.: US 2013/0295489 A1
(43) Pub. Date: Nov. 7, 2013

(54) ANODE SUPPORT FOR SOLID OXIDE FUEL CELL, METHOD OF MANUFACTURING THE SAME, AND SOLID OXIDE FUEL CELL INCLUDING THE SAME

(71) Applicant: SAMSUNG ELECTRONICS CO., LTD, Gyeonggi-do (KR)

(72) Inventors: Ju-sik KIM, Seoul (KR); Kyoung-seok MOON, Hwaseong-si (KR); Chan KWAK, Yongin-si (KR); Hee-jung PARK, Suwon-si (KR); Doh-won JUNG, Seoul (KR)

(73) Assignee: SAMSUNG ELECTRONICS CO., LTD, Gyeonggi-do (KR)

(21) Appl. No.: 13/729,476

(22) Filed: Dec. 28, 2012

(30) Foreign Application Priority Data
May 2, 2012 (KR) 10-2012-0046433

(51) Int. Cl. H01M 8/02

(52) U.S. Cl. CPC H01M 8/0271
USPC 429/508; 264/105; 264/620

(57) ABSTRACT

An anode support for a solid oxide fuel cell, the anode support having a bimodal pore distribution comprising a first pore having an average pore size of about 3 micrometers to about 10 micrometers, and a second pore having an average pore size of about 0.1 micrometer to about 1 micrometer.

This application claims priority to and the benefit of Korean Patent Application No. 10-2012-0046433, filed on May 2, 2012, all the benefits accruing therefrom under 35 U.S.C. §119, the content of which is incorporated herein in its entirety by reference.

### BACKGROUND

1. Field

The present disclosure relates to an anode support for a solid oxide fuel cell, a method of manufacturing the same, and a solid oxide fuel cell including the same.

2. Description of the Related Art

A solid oxide fuel cell (SOFC) is a highly efficient energy conversion device that directly converts the chemical energy of a fuel gas into electrical energy. Compared to other types of fuel cells, such as a phosphoric acid fuel cell or a molten carbonate fuel cell, an SOFC has higher efficiency since an SOFC operates at a higher temperature, can directly use various hydrocarbon-based fuels without having to use a reformer, and can use relatively lower cost materials. An SOFC includes a cathode where a reduction of an oxygen containing gas occurs, an electrolyte comprising an ion conductor, and an anode where oxidation of a fuel gas occurs.

An SOFC can be a tubular type (including a flat tubular type) or a planar type, according to a shape of a support. A planar type SOFC has a high unit cell power density due to having a low internal ohmic resistance compared to a tubular type SOFC, but it is difficult for a planar type SOFC to have a large area due to a gas sealing issue and a difference between the thermal coefficients of components. Accordingly, instead of a planar type SOFC, a tubular type SOFC is often used for large capacity fuel cells for power generation. A tubular type SOFC can be cathode supported or anode supported. An anode supported SOFC is often developed since it provides excellent mechanical strength, easier electrolyte coating, and lower material costs when compared to a cathode supported SOFC. A cermet, i.e., a composite of a metal and a ceramic, is widely used as a material of an anode support, and nickel oxide/yttria-stabilized zirconia (NiO/YSZ), which has excellent hydrogen catalytic characteristics and acceptable cost, is often used.

A tubular type (including a flat tubular type) anode support is desirably capable of co-firing and desirably provides low reactivity with other components (e.g., an electrolyte layer and an anode functional layer), is desirably capable of contraction at a high temperature to form a dense electrolyte on a surface thereof, and desirably provides sufficient mechanical strength to form a fuel cell stack. Furthermore, a tubular type anode support desirably has sufficient electrical conductivity to provide satisfactory current flow, and has a sufficiently porous structure having a uniform pore distribution to suitably supply a fuel gas to a reaction layer. Thus it would be desirable to develop an anode support that has sufficient mechanical strength, has a surface on which a material can be satisfactorily disposed, and is suitably porous so as to provide an SOFC having improved performance.

### SUMMARY

Provided is an anode support for a solid oxide fuel cell (SOFC) that has excellent adhesiveness with an electrolyte, has a high surface area, and easily diffuses a fuel gas to a reaction layer.

Provided is a method of manufacturing the anode support.

Provided is an SOFC including the anode support.

Additional aspects will be set forth in part in the description which follows and, in part, will be apparent from the description.

According to an aspect, disclosed is an anode support for a solid oxide fuel cell (SOFC), the anode support having a bimodal pore distribution including a first pore having an average pore size of about 3 micrometers (μm) to about 10 μm, and a second pore having an average pore size of about 0.1 μm to about 1 μm.

An average absolute deviation of the first pore may be less than or equal to about ±3 μm.

An average absolute deviation of the second pore may be less than or equal to about ±0.5 μm.

A porosity of the anode support may be from about 30 volume percent (volume %) to about 50 volume %.

A volume occupied by the first pore may be about 10 volume % to about 35 volume %.

A root-mean-square surface roughness of the anode support may be less than or equal to about ±10 μm.

According to another aspect, disclosed is a method of manufacturing an anode support for a solid oxide fuel cell (SOFC), the anode support having a bimodal pore distribution, the method including: combining a carbonaceous pore former having an average particle size from about 3 μm to about 10 μm, a matrix material, and nickel oxide (NiO) to form a composition; molding the composition; thermally processing the molded composition; and contacting the thermally processed molded composition with hydrogen to manufacture the anode support.

An average particle size of the NiO may be from about 0.1 μm to about 1 μm.

The carbonaceous pore former may include at least one selected from carbon powder, carbon black, acetylene black, active carbon, natural graphite, artificial graphite, graphene, carbon fiber, fullerene, carbon nanotube, carbon nanowire, carbon nanohorn, and carbon nanoring.

An amount of the carbonaceous pore former may be from about 1 to about 30 parts by weight, based on 100 parts by weight of the total weight of the matrix material and the NiO.

The combining may further include combining a dispersant which is effective to prevent agglomeration of the carbonaceous former.

The thermally processing may include: pre-sintering the molded mixture; disposing an electrolyte layer on the pre-sintered molded composition; and co-firing the pre-sintered molded composition and the electrolyte layer disposed thereon.

The pre-sintering may be performed at a temperature from about 1000° C. to about 1200° C.

A root-mean-square surface roughness of the pre-sintered molded mixture may be less than or equal to about ±10 μm.

The co-firing may be at a temperature from about 1300° C. to about 1500° C.

The bimodal pore distribution may include a first pore having an average pore size from about 3 μm to about 10 μm, and a second pore having an average pore size from about 0.1 μm to about 1 μm.

According to another aspect, a solid oxide fuel cell includes the anode support.

### BRIEF DESCRIPTION OF THE DRAWINGS

These and/or other aspects will become apparent and more readily appreciated from the following description of the embodiments, taken in conjunction with the accompanying drawings in which:

FIG. 1 is a cross-sectional view schematically illustrating a structure of an embodiment of a solid oxide fuel cell (SOFC);

FIG. 2 is a scanning electron microscope (SEM) image showing a cross section of an end cell manufactured in Example 1;

FIG. 3 is an SEM image of an anode support of the end cell of Example 1;

FIG. 4 is an SEM image of a rectangular portion of the anode support of FIG. 3, showing a large pore;

FIG. 5 is a graph of voltage (V, volts) and power density (Watts per square centimeter, W/cm²) versus current density (amperes per square centimeter, A/cm²) of the end cell of Example 1 and an end cell manufactured in Comparative Example 1; and

FIG. 6 is a graph of reactance (−Z″, ohms-square centimeters) versus resistance (Z′, ohms-square centimeters) showing impedance of the end cells of Example 1 and Comparative Example 1.

### DETAILED DESCRIPTION

Reference will now be made in detail to embodiments, examples of which are illustrated in the accompanying drawings. Expressions such as “at least one of,” when preceding a list of elements, modify the entire list of elements and do not modify the individual elements of the list.

An anode support for a solid oxide fuel cell (SOFC) according to an embodiment has a bimodal pore distribution including a first pore having an average pore size from about 3 micrometers (μm) to about 10 μm, and a second pore having an average pore size from 0.1 μm to about 1 μm.

An anode support may be manufactured by combining a binder, an additive, and a pore former, such as carbon black, and a nickel oxide-yttria-stabilized zirconia (NiO-YSZ) matrix material to provide a molding composition, and extrusion-molding the molding composition to provide a molded body. Then, the molded body may be thermally processed at a high temperature to burn out the pore former, thereby forming pores in a support. While not wanting to be bound by theory, it is understood that because a carbon-based pore former has a pore size of less than or equal to 1 millimeter, and thus it is difficult to form a large open pore which provides for easy fuel gas penetration. Also, it is understood that porosity is decreased and pore distribution is not uniform due to agglomeration of the pore former when an amount of the carbon-based pore former is increased.

In an embodiment, the anode support according to an embodiment has the bimodal pore distribution wherein the first pore having the relatively large pore size and the second pore having the relatively small pore size are uniformly distributed, and thus the anode support has a relatively high surface area and the anode support enables a fuel gas to be easily diffused therethrough.

According to an embodiment, the average pore size of the first pore is in the range from about 3 μm to about 10 μm, specifically about 4 μm to about 9 μm, more specifically about 5 μm to about 8 μm, and an average absolute deviation of the first pore, i.e., a mean absolute deviation, may be less than or equal to about ±3 μm, specifically about ±3 μm to about ±0.5 μm, more specifically ±2.5 μm to about ±1 μm. As such, the first pore having the relatively large size enables easy fuel gas penetration, thereby suppressing a concentration polarization that can cause performance deterioration.

Also, the average pore size of the second pore is in the range from about 0.1 μm to about 1 μm, specifically about 0.2 μm to about 0.9 μm, more specifically about 0.4 μm to about 0.8 μm, and an average absolute deviation of the second pore may be less than or equal to about ±0.5 μm, specifically about ±0.5 μm to about ±0.1 μm, more specifically ±0.4 μm to about ±0.2 μm. As such, the second pore having the relatively small size may increase adhesiveness with an electrolyte by decreasing a surface roughness of the anode support, and may increase a surface area available for fuel oxidation.

Here, an “average pore size” denotes a pore size at a point when a volume percentage is 50% in an accumulation curve of a pore distribution when a total volume is 100%, and thus denotes a pore size (i.e. pore diameter) (hereinafter, referred to as D₅₀) when a volume is 50% by accumulating pores from a small size to a large size.

An average pore size may be measured via any one of well known methods, and for example, an accumulation curve of a pore volume distribution may be obtained via an optical microscope or electron microscope method, an X-ray scattering method, a gas-adsorption method, a mercury intrusion method, a liquid extrusion method, a molecular weight cut off method, a fluid displacement method, or a measuring method using pulse nuclear magnetic resonance (NMR), and a D₅₀ may be determined at a point where an accumulation frequency of volume distribution is 50%.

According to an embodiment, the anode support may have surface roughness lower than or equal to about ±10 μm according to uniform distribution of the first and second pores.

According to an embodiment, porosity of the anode support may be from about 30 volume % to about 50 volume %, and here, a volume occupied by the first pore may be from about 10 volume % to about 35 volume %. Within the stated range, a fuel gas quickly diffuses to an anode reaction layer. In an embodiment, the porosity of the anode may be about 35 volume % to about 45 volume %, specifically about 40 volume %. Also, the volume occupied by the first pore may be from about 15 volume % to about 30 volume %, specifically about 20 volume % to about 25 volume %.

The anode support may be molded to provide a tubular type, a flat tubular type, or a planar type support suitable for an SOFC, but a shape of the anode support is not limited thereto, and the anode support may be molded to any suitable.

According to another embodiment, a method of manufacturing the anode support for an SOFC having the bimodal pore distribution, includes preparing a composition for an anode support by adding a carbonaceous pore former having an average particle size from about 3 μm to about 10 μm to a mixture of a matrix material and NiO, molding the composition, e.g., via an extrusion or a pressing method, thermally processing the molded composition, and reducing the thermally processed molded composition under a hydrogen atmosphere.

In an embodiment, the method of manufacturing the anode support for an SOFC having the bimodal pore distribution comprises combining a carbonaceous pore former having an average particle size from about 3 micrometers to about 10 micrometers, a matrix material, and nickel oxide to form a composition; molding the composition; thermally processing the molded composition; and contacting the thermally processed molded composition with hydrogen to manufacture the anode support. In an embodiment, the molding may comprise extrusion molding or press molding. In another embodiment the carbonaceous pore former can be added to a mixture of the matrix material and the nickel oxide.

While preparing the composition for an anode support, since the matrix material desirably provides for electrochemical oxidation of a fuel and a charge transfer, the matrix material desirably has suitable fuel oxidation catalytic properties, chemical stability with an electrolyte material, and a coefficient of thermal expansion which is similar to a coefficient of thermal expansion of the electrolyte material. The matrix material may comprise a material that is suitable for a solid oxide electrolyte.

For example, the matrix material may include at least one selected from zirconia; zirconia or doped with at least one selected from yttrium, scandium, calcium, and magnesium; ceria; ceria doped with at least one selected from gadolinium, samarium, lanthanum, ytterbium, and neodymium; a bismuth oxide, a bismuth oxide doped with at least one selected from calcium, strontium, barium, gadolinium, and yttrium; lanthanum gallate, and lanthanum gallate doped with at least one selected from strontium and magnesium.

NiO is a material that forms a cermet with the matrix material, and may have an average particle size from about 0.1 μm to about 1 μm, specifically about 0.2 μm to about 0.9 μm, more specifically about 0.3 μm to about 0.8 μm. The anode support is under a reducing atmosphere when the fuel cell is operating. While not wanting to be bound by theory, it is understood that under the reducing atmosphere, NiO may be reduced to Ni, thereby forming the second pore having the relatively small size in the anode support.

The matrix material and NiO may be combined in a suitable ratio. Electrical conductivity may be increased when an amount of nickel in the anode support is increased, but if the amount of nickel is excessive, the anode support may fracture due to a difference between a coefficient of thermal expansion of nickel and other components. Thus, the amount of nickel may be selected to be within a range for obtaining a desired electrical conductivity while not substantially increasing the difference of the coefficient of thermal expansion. For example, the matrix material and NiO may be combined in a weight ratio of about 6:4 to about 7:3, specifically about 1.6 to about 2.2, more specifically about 1.7 to about 2.1.

The carbonaceous pore former has an average particle size from about 3 μm to about 10 μm, specifically about 4 μm to about 9 μm, more specifically about 5 μm to about 8 μm, and forms the first pore having the average pore size from about 3 μm to about 10 μm, specifically about 4 μm to about 9 μm, more specifically about 5 μm to about 8 μm, in the anode support, and may be removed during pre-sintering.

The carbonaceous pore former may include at least one selected from carbon powder, carbon black, acetylene black, active carbon, natural graphite, artificial graphite, graphene, carbon fiber, fullerene, carbon nanotube, carbon nanowire, carbon nanohorn, and carbon nanoring.

The carbonaceous pore former may be added to provide a porosity that enables suitable fuel gas diffusion. If an amount of the carbonaceous pore former is excessive, a surface area may be reduced and support strength of the anode support may be decreased, and thus the amount of the carbonaceous pore former may be selected to be within a suitable range. For example, the carbonaceous pore former may be added within a range from about 1 to about 30 parts by weight, for example, from about 5 to about 20 parts by weight, for example, from about 8 to about 12 parts by weight, based on 100 parts by weight of the mixture of the matrix material and NiO.

Also, the composition may further include a dispersant for preventing agglomeration of the carbonaceous pore former. Examples of the dispersant include at least one selected from an ester surfactant type dispersant (i.e., an ester dispersant), and a high molecular copolymer type dispersant (i.e., a copolymer dispersant). Representative dispersants include SN-Dispersant 5077 available from San Nopco Korea LTD., SN-Dispersant 5088 available from San Nopco Korea LTD., SN-Dispersant 5020 available from San Nopco Korea LTD., Lomar D available from GEO Specialty Chemicals, Lomar PW-40 available from GEO Specialty Chemicals, Lomar PWA-40 available from GEO Specialty Chemicals, Cerasperse 44-CF available from San Nopco Korea LTD., Cerasperse 5020-CF available from San Nopco Korea LTD., Cerasperse 5468-CF available from San Nopco Korea LTD., SN-Dispersant 9228 available from San Nopco Korea LTD., SN-Dispersant 7347 available from San Nopco Korea LTD., SN-Dispersant 5033 available from San Nopco Korea LTD., Tenlo 70 available from BASF, and a dispersant available from BYK.

Raw materials of the composition may be combined using a planetary ball mill, an electric ball mill, a ball mill, a vibration ball mill, or a high speed mixer.

According to an embodiment, the thermal processing may include pre-sintering the molded composition, and co-firing the pre-sintered molded composition with an electrolyte layer coated thereon.

The pre-sintering is performed to burn out and remove the carbonaceous pore former, and may be performed at a temperature from about 600° C. to about 1200° C., specifically about 1000° C. to about 1200° C., more specifically about 1050° C. to about 1150° C. When the pre-sintering is performed within the above temperature range, the pre-sintered molded composition may provide sufficient strength for a subsequent electrolyte coating process while preventing generation of a crack caused by excessive contraction.

According to an embodiment, after the pre-sintering, a surface roughness, e.g., a root-mean-square surface roughness (R_{RMS}), of the pre-sintered molded composition may be less than or equal to ±10 μm, specifically about ±1 μm to about ±10 μm, more specifically about ±2 μm to about ±8 μm, when the carbonaceous pore former is removed.

The pre-sintered molded composition may be co-fired after coating an electrolyte slurry thereon. The co-firing may be performed at a temperature from about 1300° C. to about 1500° C., for example, from about 1350° C. to about 1450° C. The pre-sintered molded composition and the electrolyte slurry may be satisfactorily fired when the temperature is within the above range.

While not wanting to be bound by theory, it is understood that when the thermally processed molded composition is contacted with hydrogen (H₂), NiO is reduced to Ni, thereby forming the second pore having the average pore size from about 0.1 μm to about 1 μm, specifically about 0.2 μm to about 0.9 μm, more specifically about 0.4 μm to about 0.8 μm. The reduction may be performed according to a separate reduction process or by assembling an SOFC and setting only an anode to contact hydrogen. Alternatively, generally, NiO may be naturally reduced to Ni under a fuel atmosphere while operating an SOFC.

The anode support manufactured as such has the bimodal pore distribution wherein a relatively large pore (i.e., the first pore) and a relatively small pore (i.e., the second pore) are uniformly distributed. Here, the average pore size of the first pore is from about 3 μm to about 10 μm, and the average pore size of the second pore is from about 0.1 μm to about 1 μm.

According to another embodiment, an SOFC including the anode support is provided.

The SOFC according to an embodiment includes an anode including the anode support, a cathode facing the anode, and a solid oxide electrolyte disposed between the anode and the cathode.

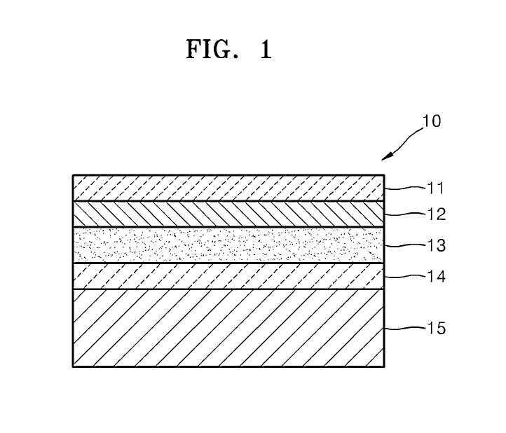

FIG. 1 is a cross-sectional view schematically illustrating a structure of an embodiment of an SOFC 10. Referring to FIG. 1, the SOFC 10 includes a cathode 11 and an anode 15 on opposite sides of a solid oxide electrolyte 13. A buffer layer 12 for preventing a reaction between the cathode 11 and the solid oxide electrolyte 13 may be further disposed between the cathode 11 and the solid oxide electrolyte 13, and an anode functional layer 14 may be further disposed between the anode 15 and the solid oxide electrolyte 13.

The cathode 11 (e.g., air electrode) is effective to reduce an oxygen containing gas to oxygen ions, and a substantially constant oxygen partial pressure may be maintained by continuously supplying air to the cathode 11. A material of the cathode 11 is not limited as long as it is suitable for a fuel cell cathode, and may comprise metal oxide particles having a perovskite crystalline structure. Since a perovskite metal oxide is a mixed ionic and electronic conductor (MIEC) material having a high oxygen diffusion coefficient and a high charge exchange reaction velocity coefficient, oxygen reduction may occur on a three phase interface and also on an entire surface of an electrode. Thus, the perovskite metal oxide has an excellent electrode activity at a low temperature, thereby contributing to reduction of an operation temperature of the SOFC 10. The perovskite metal oxide may be represented by Formula 1 below.

ABO_{3±γ} Formula 1

In Formula 1, A denotes at least one element selected from lanthanum (La), barium (Ba), strontium (Sr), samarium (Sm), gadolinium (Gd), and calcium (Ca), B denotes at least one element selected from manganese (Mn), iron (Fe), cobalt (Co), nickel (Ni), copper (Cu), titanium (Ti) niobium (Nb), chromium (Cr), and scandium (Sc), and γ denotes an excess or deficient amount of oxygen.

In an embodiment, γ may have a range of 0≦γ≦0.3.

For example, the perovskite metal oxide may be represented by Formula 2 below.

A′₁₋ₓA″ₓB′O_{3±γ} Formula 2

In Formula 2, A′ denotes at least one element selected from Ba, La, and Sm, A″ denotes at least one element of Sr, Ca, and Ba and thus is different from A′, B′ denotes at least one element selected from Mn, Fe, Co, Ni, Cu, Ti, Nb, Cr, and Sc, 0≦x<1, and γ denotes an excess or deficient amount of oxygen.

Examples of such a perovskite metal oxide include barium strontium cobalt iron oxide (BSCF), lanthanum strontium cobalt oxide (LSC), lanthanum strontium cobalt iron oxide (LSCF), lanthanum strontium cobalt manganese oxide (LSCM), lanthanum strontium iron oxide (LSF), and samarium strontium cobalt oxide (SSC).

In detail, examples of the perovskite metal oxide include Ba₁₋ₓSrₓCo_{1-y}Fe_{y}O₃, wherein 0.1≦x≦0.5 and 0.05≦y≦0.5, BaₐSr_{b}CoₓFe_{y}Z_{1-x-y}O_{3±y}, wherein Z denotes at least one element selected from among transition metal elements and lanthanum group elements, 0.4≦a≦0.6, 0.4≦b≦0.6, 0.6≦x≦0.9, and 0.1≦y≦0.4, La₁₋ₓSrₓFe_{1-y}Co_{y}O_{3±y}, wherein 0.1≦x≦0.4 and 0.05≦y≦0.5, and Sm₁₋ₓSrₓCoO₃, wherein 0.1≦x≦0.5. For example, an oxide such as Ba_{0.5}Sr_{0.5}Co_{0.5}Fe_{0.2}O_{3±y}, Ba_{0.5}Sr_{0.5}Co_{0.8}Fe_{0.1}Z_{0.1}O_{3±y}, wherein Z denotes Mn, Zn, Ni, Ti, Nb, or Cu, La_{0.6}Sr_{0.4}Co_{0.2}Fe_{0.8}O_{3±y}, or Sm_{0.5}Sr_{0.5}CoO₃ may be used. The perovskite metal oxide may be used alone or in combination of at least two types. A transition metal element is an element of Groups 3 to 12 of the Periodic Table.

A thickness of the cathode 11 may be from about 1 μm to about 100 μm. For example, the thickness of the cathode 11 may be from about 5 μm to about 50 μm.

The cathode 11 may be sufficiently porous for an oxygen gas to be satisfactorily diffused in the cathode 11.

The buffer layer 12 may be further disposed between the cathode 11 and the solid oxide electrolyte 13 if desired so as to effectively prevent a reaction therebetween. The buffer layer 12 may include at least one selected from gadolinium doped ceria (GDC), samarium doped ceria (SDC), and yttrium doped ceria (YDC). A thickness of the buffer layer 12 may be from about 1 μm to 50 μm, for example, from about 2 μm to about 10 μm.

The solid oxide electrolyte 13 is desirably sufficiently dense for air and a fuel to not be mixed, and has a high oxygen ion conductivity and a low electron conductivity. Also, since the cathode 11 and the anode 15 having a very high oxygen partial pressure difference are disposed on sides of the solid oxide electrolyte 13, the above properties need to be maintained in a wide oxygen partial pressure region.

A material of the solid oxide electrolyte 13 is not limited as long as it is generally used in the related fields, and for example, the solid oxide electrolyte 13 may include at least one selected from zirconia-based, ceria-based, bismuth oxide-based, and lanthanum gallate-based solid electrolytes. For example, the solid oxide electrolyte 13 may include at least one selected from zirconia; zirconia doped with at least one selected from yttrium, scandium, calcium, and magnesium; ceria; ceria doped with at least one selected from gadolinium, samarium, lanthanum, ytterbium, and neodymium; a bismuth oxides; a bismuth oxide doped with at least one selected from calcium, strontium, barium, gadolinium, and yttrium; lanthanum gallate; and lanthanum gallate doped with at least one selected from strontium and magnesium. Examples of the solid oxide electrolyte include yttria-stabilized zirconia (YSZ), scandium-stabilized zirconia (ScSZ), samaria doped ceria (SDC), and gadolinia doped ceria (GDC).

A thickness of the solid oxide electrolyte 13 may be from about 10 nm to about 100 μm. For example, the thickness of the solid oxide electrolyte 13 may be from about 100 nm to about 50 μm.

The anode 15 (e.g., the fuel electrode) is effective to electrochemically oxidize a fuel and transfers electrical charge. The anode 15 may include the anode support disclosed above, and additional details about the anode support are not repeated. A thickness of the anode 15 may be from about 1 μm to about 1000 μm. For example, the thickness of the anode 15 may be from about 5 μm to about 100 μm.

The anode functional layer 12 including a composite of NiO and a solid oxide electrode material may be disposed between the anode 15 and the solid oxide electrolyte 13, if desired, so as to prevent a reaction therebetween. Examples of NiO mixed with the solid oxide electrolyte material are as described above, and in detail, YSZ, ScSZ, SDC, or GDC may be used.

According to an embodiment, the SOFC 10 may further include an electricity collecting layer (not shown) including an electronic conductor outside the cathode 11 and on at least one side of the cathode 11. The electricity collecting layer may operate as a current collector for collecting electricity in the cathode 11.

The electricity collecting layer may include at least one selected from lanthanum cobalt oxide (LaCoO₃), lanthanum strontium cobalt oxide (LSC), lanthanum strontium cobalt iron oxide (LSCF), lanthanum strontium cobalt manganese oxide (LSCM), lanthanum strontium manganese oxide (LSM), and lanthanum strontium iron oxide (LSF). The electricity collecting layer may comprise one or a combination of at least two of the above listed materials. Alternatively, the electricity collecting layer may be have a single layer or have a stacked structure of at least two layers by using the above materials.

The SOFC 10 may be manufactured using any general method published in various documents in the related fields. Also, the SOFC 10 may have any one of various structures, such as a tubular type stack, a flat tubular type stack, and a planar type stack.

The embodiments will be described in greater detail with reference to the following examples. The following examples are for illustrative purposes only and shall not limit the scope of this disclosure.

### Example 1

NiO (average particle size 0.3 micrometers (μm)) and 8 mole percent (mol %) YSZ (Y₂O₃-stabilized-ZrO₂) powder were mixed at a weight ratio of 7:3, 1 weight percent (wt %) of SN-dispersant 9228 (available from SAN NOPCO KOREA LTD.) as a dispersant and 6 wt % of ethylene glycol as a plasticizer were added thereto, and the obtained mixture was ball-milled for 24 hours in ethanol with a high purity zirconia ball. Then, carbon black having an average particle size from about 3 μm to about 6 μm was added as a pore former in an amount of 10 parts by weight, based on 100 parts by weight of the NiO and YSZ powder, and the mixture ball-milled for an additional 24 hours. After the ball-milling, the product was stirred and dried to obtain an anode support powder. The anode support powder was dry-pressed to be molded into a tubular shape (diameter 30 mm and thickness 1 mm), and then pre-sintered at 950° C. to manufacture a porous NiO-YSZ anode support.

An anode functional layer (AFL) was formed on the anode support by coating a scandia-stabilized ZrO₂ (NiO—ScSZ) composite slurry three times via a dip-coating method and then thermally processing the NiO—ScSZ at 900° C. Then, an ScSZ slurry was coated on the AFL three times via a dip-coating method and then thermally processed at 1400° C. to form a dense electrolyte layer having a thickness of 20 μm. Gd-doped CeO₂ (GDC) as a buffer layer between a cathode and an electrolyte was coated on the electrolyte layer, and then a composite cathode (Ba_{0.5}Sr_{0.5}Co_{0.8}Fe_{0.1}Zn_{0.1}O₃ (BSCFZ, 50 wt %) and La_{0.8}Sr_{0.2}Co_{0.5}Fe_{0.5}O₃ (LSCF, 50 wt %)) composed via an EDTA method was coated on the GDC layer, and then thermally processed at 900□ to manufacture an SOFC end cell.

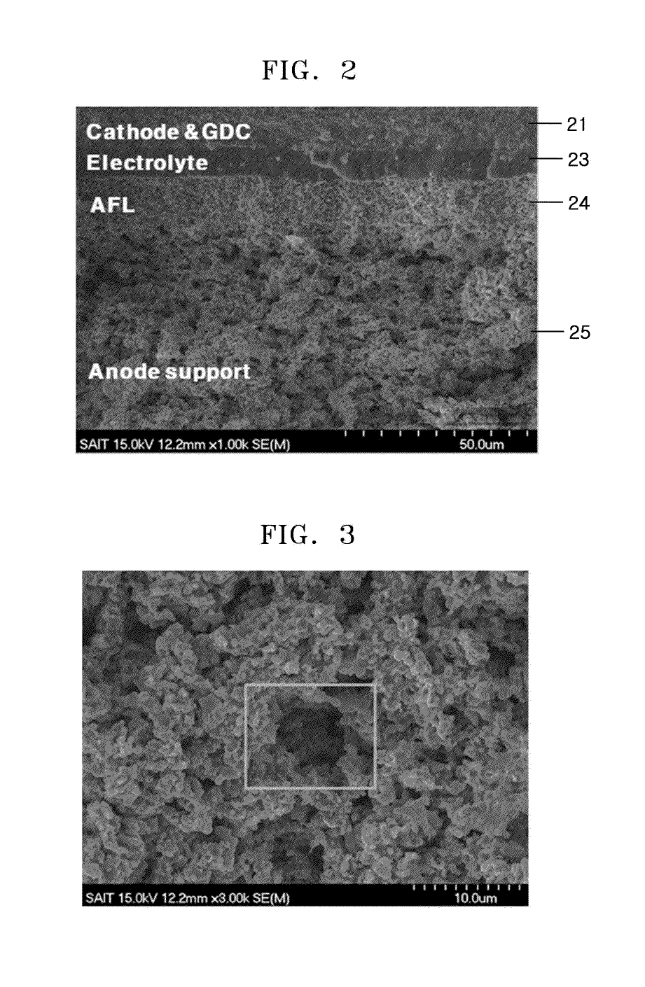

The SOFC end cell was configured such that only the anode contacted hydrogen, and then the anode support was reduced by adding hydrogen. Next, a cross section of the SOFC end cell was observed under a scanning electron microscope (SEM). An SEM image thereof is shown in FIG. 2. Shown in FIG. 2 is a cathode and gadolinium doped ceria (GDC) buffer layer 21, a solid electrolyte 23, an anode functional layer 24, and an anode support 25.

### Comparative Example 1

An SOFC end cell was manufactured in the same manner as in Example 1 except that an anode support was manufactured by adding carbon black having an average particle size of about 1 μm as a pore former.

### Evaluation Example 1

### Measurement of Microstructure of Anode Support

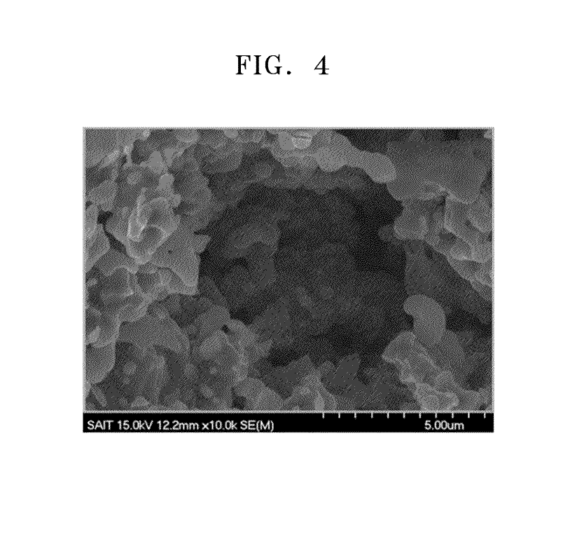

Since an anode support is under a reducing atmosphere during operation of the fuel cell, in order to observe a microstructure of the anode support after reduction, the anode support used in Example 1 was separately reduced for 2 hours under an H₂ atmosphere at 800° C. The microstructure of the anode support after the reduction was checked using a SEM, and a result thereof is shown in FIGS. 3 and 4.

As shown in FIGS. 3 and 4, relatively large pores (first pores) having sizes from about 3 μm to about 6 μm are uniformly distributed, and relatively small pores (second pores) having sizes from about 0.5 μm to about 1 μm are uniformly distributed between the relatively large pores. Shapes of the first pores are determined by a shape and size of a pore former, and the second pores are voluntarily formed via a reduction of NiO.

### Evaluation Example 2

### Measurement of Current-Voltage and Output Density

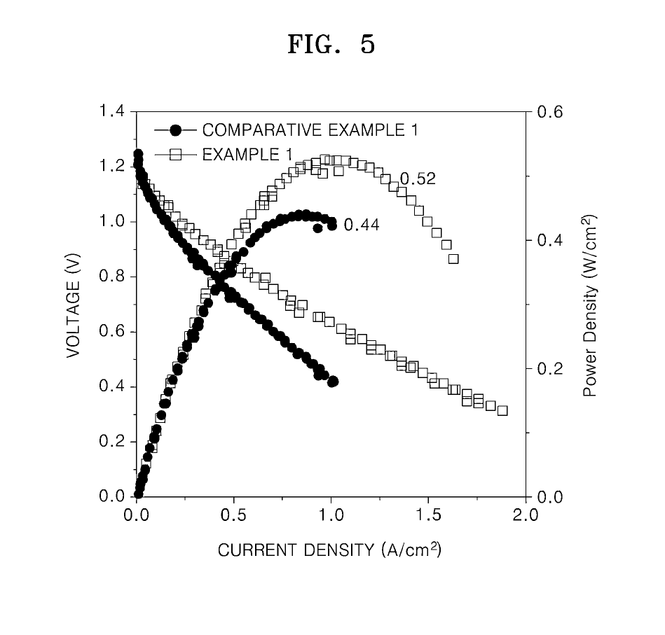

Current-voltage (I-V) and current-power (I-P) tests were performed on the SOFC end cells of Example 1 and Comparative Example 1. A digital multimeter (K2420, Keithley) was used for measurement. A cathode atmosphere was air and an anode atmosphere was hydrogen containing 3% of water (H₂O). A gas flow rate was 1000 cubic centimeters per minute (cc/min) and a measurement temperature was from about 650° C. to about 800° C. I-V curves and output density results of the SOFC end cells of Example 1 and Comparative Example 1 are shown in FIG. 5.

As shown in FIG. 5, concentration polarization wherein a voltage and an output are remarkably reduced at a relatively low current density was observed in an anode support using carbon black having a size similar to NiO (Comparative Example 1). This may be because a gas penetration rate of the anode support is low, and thus a supply rate of a hydrogen fuel to an anode reaction layer is lower than an electrochemical reaction rate at the anode at a high current.

On the other hand, performance of an anode support having a bimodal pore structure prepared by using carbon black having a particle size larger than NiO as a pore former was improved. Concentration polarization was observed at a high current equal to or higher than 1 A/cm² and a maximum output density obtained at 700° C. was 0.52 W/cm² (Example 1). This shows that each SOFC forming layer is effectively coated on a surface of the anode support. Also, as provided by the microstructure shown in FIG. 2, the performance of the anode support may be increased since an anode electrochemical reaction rate is not constrained by a fuel concentration as movement of a hydrogen fuel gas in the anode support is increased by the uniform distribution of large pores and small pores.

### Evaluation Example 3

### Measurement of Polarization Resistance

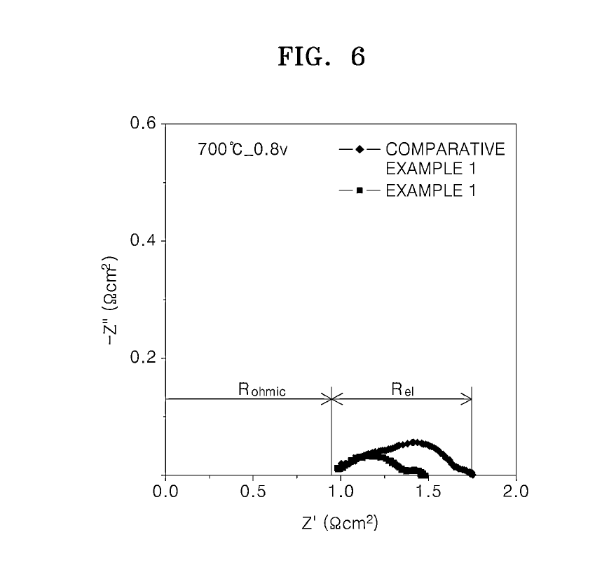

In order to observe polarization resistance of the SOFC end cells of Example 1 and Comparative Example 1, an electrochemical impedance test (EIS) was performed using an impedance analyzer (Solartron 1260A+1287 potentiostat). Results of impedance analysis of each SOFC end cell are shown in FIG. 6. A semicircle in an intermediate frequency region in FIG. 6 generally denotes an anode resistance with respect to a hydrogen oxidation.

As shown in FIG. 6, a semicircle of the SOFC end cell of Example 1 in an intermediate frequency region is smaller than a semicircle of the SOFC end cell of Comparative Example 1. This shows that the anode reaction resistance is decreased, consistent with the result of the I-V curve. Accordingly, it may be concluded that when an anode support having a bimodal pore structure is used as in Example 1, an overall anode reaction rate is increased since an area of an anode reaction layer is large and a fuel gas is easily moved to a reaction layer.

As described above, according to the one or more of the above embodiments, since the anode support for an SOFC has a uniform pore distribution of a bimodal system, the anode support has improved adhesiveness with an electrolyte, and can provide increased anode reaction rate by providing a high surface reaction area and easy fuel gas diffusion to a reaction layer.

It should be understood that the exemplary embodiments described therein should be considered in a descriptive sense only and not for purposes of limitation. Descriptions of features, advantages, or aspects within each embodiment shall be considered as available for other similar features, advantages, or aspects in other embodiments.

What is claimed is:

1. An anode support for a solid oxide fuel cell (SOFC), the anode support having a bimodal pore distribution comprising
a first pore having an average pore size of about 3 micrometers to about 10 micrometers, and
a second pore having an average pore size of about 0.1 micrometer to about 1 micrometer.

2. The anode support of claim 1, wherein an average absolute deviation of the first pore is less than or equal to about ±3 micrometers.

3. The anode support of claim 1, wherein an average absolute deviation of the second pore is less than or equal to about ±0.5 micrometer.

4. The anode support of claim 1, wherein a porosity of the anode support is from about 30 volume percent to about 50 volume percent.

5. The anode support of claim 1, wherein a volume occupied by the first pore is about 10 volume percent to about 35 volume percent.

6. The anode support of claim 1, wherein a root-mean-square surface roughness of the anode support is less than or equal to about ±10 micrometers.

7. A method of manufacturing an anode support for a solid oxide fuel cell (SOFC), the anode support having a bimodal pore distribution, the method comprising:
combining a carbonaceous pore former having an average particle size from about 3 micrometers to about 10 micrometers, a matrix material, and nickel oxide to form a composition;
molding the composition;
thermally processing the molded composition; and
contacting the thermally processed molded composition with hydrogen to manufacture the anode support.

8. The method of claim 7, wherein the molding comprises extrusion molding or press molding.

9. The method of claim 7, wherein the matrix material comprises at least one selected from: zirconia; zirconia doped with at least one selected from yttrium, scandium, calcium, and magnesium; ceria; ceria doped with at least one selected from gadolinium, samarium, lanthanum, ytterbium, and neodymium; a bismuth oxide; a bismuth oxide doped with at least one selected from calcium, strontium, barium, gadolinium, and yttrium; lanthanum gallate; and lanthanum gallate doped with at least one selected from strontium and magnesium.

10. The method of claim 7, wherein an average particle size of the nickel oxide is from about 0.1 micrometer to about 1 micrometer.

11. The method of claim 7, wherein a weight ratio of the matrix material to the nickel oxide is from about 6:4 to about 7:3.

12. The method of claim 7, wherein the carbonaceous pore former comprises at least one selected from carbon powder, carbon black, acetylene black, active carbon, natural graphite, artificial graphite, graphene, carbon fiber, fullerene, carbon nanotube, carbon nanowire, carbon nanohorn, and carbon nanoring.

13. The method of claim 7, wherein an amount of the carbonaceous pore former is from about 1 to about 30 parts by weight, based on 100 parts by weight of the total weight of the matrix material and the NiO.

14. The method of claim 7, wherein the combining further comprises combining a dispersant which is effective to prevent agglomeration of the carbonaceous former.

15. The method of claim 14, wherein the dispersant is at least one selected from an ester dispersant, and a copolymer dispersant.

16. The method of claim 7, wherein the thermally processing comprises:
pre-sintering the molded composition;
disposing an electrolyte layer on the pre-sintered molded composition; and
co-firing the pre-sintered molded composition and the electrolyte layer disposed thereon.

17. The method of claim 16, wherein the pre-sintering is performed at a temperature from about 1000° C. to about 1200° C.

18. The method of claim 16, wherein a root-mean-square surface roughness of the pre-sintered molded mixture is less than or equal to about ±10 micrometers.

19. The method of claim 16, wherein the co-firing is performed at a temperature from about 1300° C. to about 1500° C.

20. The method of claim 7, wherein the bimodal pore distribution comprises a first pore having an average pore size from about 3 micrometers to about 10 micrometers, and a second pore having an average pore size from about 0.1 micrometer to about 1 micrometer.

21. A solid oxide fuel cell comprising an anode support according to claim 1.
